(19) United States
(12) Patent Application Publication
(10) Pub. No.: US 2009/0254804 A1
(43) Pub. Date: Oct. 8, 2009

(54) Method and system for managing bipolar disoder in a patient

(76) Inventor: Benjamin F. McGraw, IV, Woburn, MA (US)

Correspondence Address: Scott R. Foster;Pandiscio & Pandiscio, P.C., 470 Totten Pond Road, Waltham, MA, 02451, US

(21) Appl. No.: 12/383,758

(22) Filed: Mar. 26, 2009

Related U.S. Application Data
(60) Provisional application No. 61/072,205, filed on Mar. 28, 2008.

(51) Int. Cl. G06F 17/00

(52) U.S. Cl. 715/224

(57) ABSTRACT

A method and system for managing bipolar disorder in a patient, by providing an electronic journal for the patient and a plurality of electronic stations for participants in communication with the journal and with selected other electronic stations, wherein there can be recorded and communicated by the patient, and by the participants, pertinent data, patient events, and patient responses to events, selected ones of the data, events and responses being unavailable to the patient, and unavailable to selected ones of the stations, the journal including a calendaring and timing facility to identify, report, and record dates and times of events, medical tests results, and information relative to medical and related matters, persons to be contacted under specified conditions, medicines prescribed, and medicines and other consumables deemed helpful or harmful, wherein the journal and stations are adapted to build a history of events and data overtime.

### REFERENCE TO PRIOR PATENT APPLICATION

This application claims the benefit of U.S. Provisional Patent Application Ser. No. 61/072,205, filed Mar. 28, 2008, in the name of Benjamin F. McGraw, IV.

### BACKGROUND OF THE INVENTION

1. Filed of the Invention

Bipolar disorder is a category of state disorders defined by the presence of one or more episodes of an abnormally elevated state, clinically referred to as mania. Individuals who experience manic episodes commonly also experience depressive episodes or symptoms, or mixed episodes which present features of both mania and depression. Such episodes are normally separated by periods of normal state, but in some patients depression and mania may rapidly alternate, referred to as rapid cycling. The disorder has been subdivided into bipolar I, bipolar II and cyclothymia based on the type and severity of state episodes experienced.

2. Brief Description of the Prior Art

The National Alliance on Mental Illness estimates that 2.3 million Americans have bipolar disorder while an estimated 10-13 million Americans suffer from milder forms. Worldwide, the condition affects about one in every one hundred people. The disorder is not totally understood and there are currently limited long term treatment options. Psychiatrists prescribe for patients a drug regimen and consistently monitor the effect of the medication. It can take an extended period of time to get a patient stable on a treatment regimen and even if the patient is stable, changes in brain chemistry can alter the effectiveness after a period of time. Patients typically go off medications, exposing themselves to severe manic or depressive episodes.

Bipolar disorder is a life-long illness. Therefore, long-term constant monitoring of the patient is imperative. Manic episodes can end in any one of accidental death, planned suicide and/or death of others, infidelity, sexually transmitted diseases, job loss, divorce, financial losses, etc. Prolonged depression can impact relationships, careers, quality of life, etc.

It is believed that the disorder surfaces in early adulthood in the late 20's and early 30's, and has been diagnosed in children. Staying relatively healthy with bipolar disorder over a lifetime is dependent upon taking medication, maintaining proper levels of sleep, reducing triggers, such as stress, keeping track of state, and getting feedback from loved ones, assigned psychiatrists and psychologists, and others.

The risk of suicide is very high in patients who suffer from bipolar disorder and who do not receive medical attention. Between 10-15% of patients with bipolar disorder commit suicide, with risks being the highest during episodes of depression or mixed mania(simultaneous depression and mania). Some studies suggest that the risk of suicide in patients with bipolar disorder II is even higher than it is for those with bipolar disorder I, or major depressive disorder. Patients who suffer from anxiety disorder, are at greater risk of suicide.

Many pre- and early adolescent children with bipolar disorder are more severely ill than are adults with the disease. According to a 2001 study, 25% of children with bipolar disorder were seriously suicidal. They have a higher risk for mixed mania, multiple and frequent cycles, and a long duration of illness without well periods.

The economic burden of bipolar disorder is significant. It is estimated that the disorder costs the U.S. workplace about $14.1 billion annually in lost productivity, mostly due to poor functioning on the job. According to a 2006 study sponsored by the U.S. National Institute of Mental Health, bipolar disorder accounts for twice as much lost productivity as major depressive disorder (MDD), despite the fact that MDD is more prevalent. Each worker with bipolar disorder loses about 66 workdays a year compared with 27 workdays for workers with MDD. Research suggests that bipolar disorder's depressive episodes impair productivity more than its manic episodes.

Medical evidence has shown that patients with bipolar disorder have higher death rates from suicide, heart problems, and death from all causes than those in the general population. Patients who get treatment, however, experience great improvement in suicide rates, including deaths from suicide and heart disease.

### SUMMARY OF INVENTION

The method and system described herein includes an easy to use questionnaire, referred to herein as the “journal” that can be configurably filled out by a patient as needed, depending upon where the patient is in his/her treatment. A loved one and care providers can also utilize questionnaires residing in an electronic “station” in communication with the journal and other electronic stations to record patient events that may be cause for concern.

There are opened-ended text areas in the journal and stations adapted to capture unstructured patient data, to record daily diet (caffeine taken late in the day, heavy meals late in the day, excessive sugar and/or salt, skipped meals, overeating, etc.) and overall mental state information, such as self destructive behavior, abusive or violent behavior, extreme agitation or irritability, grandiose ideas, an increase in compulsive behaviors, spending, gambling, sexual activity, substance abuse, thoughts or threats of suicide, etc.

The journal is adapted to identify standard responses that may be reason for concern.

The journal provides an electronic chart that constantly changes, such that patients do not blindly enter the same information.

The journal serves as the primary means for interacting with the selected other stations and is adapted to hide the complexity of the system from the patient, unless certain functionality is needed to be triggered, such as crisis information, school or work issues, relationship issues, sleep issues, and the like. The journal is adapted to prohibit entry thereinto by any other party, if so desired by the patient. Patients enter their own information in the journal and station users can enter information into the journal, but the journal information cannot be accessed by the station users, unless the patient agrees to such access.

The above and other features of the invention, including various novel details of combinations of parts and method steps, will now be more particularly described with reference to the accompanying drawings and pointed out in the claims. It will be understood that the particular method and system embodying the invention are shown by way of illustration only and not as limitations of the invention. The principles and features of this invention may be employed in various and numerous embodiments without departing from the scope of the invention. Reference is made to the accompanying drawings in which is shown an illustrative embodiment of the invention, from which its novel features and advantages will be apparent.

### BRIEF DESCRIPTION OF THE DRAWINGS

In the drawings:

FIG. 1 is a depiction of a portion of a display of a preferred electronic journal adapted for receipt of entries from a patient and for electronic receipt from and transmission to other selected electronic stations;

FIG. 2 is a depiction of a journal display of adverse event clarification data, adapted for receipt of entries from the patient and for transmission to selected electronic stations;

FIG. 3 is a depiction of a journal display of anxiety clarification data adapted for receipt of entries from the patient and for transmission to selected electronic stations;

FIG. 4 is a depiction of a journal display of paranoia clarification data adapted for receipt of entries from the patient and for transmission to selected electronic stations;

FIG. 5 is a depiction of a journal display of psychosis clarification data adapted for receipt of entries from the patient and for transmission to selected electronic stations;

FIG. 6-8 are depictions of a portion of an electronic journal display relative to crisis triggers and crisis events and adapted for receipt of entries from the patient and for transmission to selected electronic stations;

FIG. 9 is a depiction of an electronic journal display relative to lawyer information and power of attorney for health care, directives for treatment and medications, and adapted to receive entries from the patient and for transmission to selected electronic stations;

FIG. 10 is a depiction of a portion of an electronic journal display relative to criminal or civil law matters, probation officer matters, and the like, particularly court dates, adapted to receive entries from the patient and selected stations and for transmission to selected stations;

FIG. 11 is a depiction of an electronic journal display relative to probation matters, adapted to receive entries from the patient and selected stations and for transmission to selected stations;

FIG. 12 is a depiction of an electronic journal display relative to police matters, adapted to receive entries from the patient and for transmission to selected electronic stations;

FIG. 13 is a depiction of an electronic journal display relative to expenses attributable to bipolar disorders, adapted to receive entries from the patient and for transmission to selected electronic stations;

FIG. 14 is a depiction of an electronic journal display relative to personal and professional relationships, adapted to receive entries from the patient and for transmission to selected electronic stations;

FIG. 15 is a depiction of an electronic journal display relative to school and/or work issues, adapted to receive entries from the patient and for transmission to selected electronic stations;

FIG. 16 is a depiction of an electronic journal display relative to a patient's triggers, as entered by the patient, enabling the patient to quickly retrieve information relative to events that might initiate an episode;

FIG. 17 is a depiction of an electronic journal display relative to a patient's stressors, as entered by the patient, enabling the patient to quickly retrieve information relative to events that might initiate an episode;

FIG. 18 is a depiction of an electronic journal display relative to messages and reminders, as entered by the patient and/or stations, to inform the patient as to actions required to maintain physical and mental health;

FIG. 19 is a depiction of an electronic journal display by which a patient can quickly access informational websites;

FIG. 20 is a depiction of an electronic journal display by which a patient can prompt the electronic journal to provide additional information relative to a patient-requested topic or event;

FIG. 21 is a depiction of an electronic journal and/or electronic station display enabling inquiries or requests for information from electronic stations or the journal and for logging of pertinent events into the journal;

FIG. 22 is a depiction of an electronic journal display adapted to facilitate the entry into the journal of pertinent notification data by the patient;

FIG. 23 is a depiction of a portion of an electronic journal search table by which the patient is able to quickly gather information from the journal and from stations in communication therewith relative to a bipolar disorder event or circumstance;

FIG. 24 is a depiction of an electronic journal calendar, or diary, of scheduled events pertinent to treatment or accommodation to bipolar disorder, the journal being adapted to receive entries from the patient and from stations;

FIG. 25 is a depiction of an electronic journal adapted to accept entries by the patient relative to matters germane to the patient's history and patterns or events;

FIG. 26 is a depiction of an electronic journal adapted to receive information from the patient and/or a physician's and other stations relative to current and past health care providers, emergency contacts, tests scheduled, results of examinations, prescriptions, tests, and the like;

FIG. 27 is a depiction of an electronic journal display relative to insurance information, medical appointments, prescriptions, co-pays, and the like, entered by the patient or stations in the journal;

FIG. 28 is a depiction of information relative to people designated by the patient for contact information in the event of the patient not doing well in an emergency or during times of mania and/or depression;

FIG. 29 is a depiction of information relative to prescribed medications, including dates when prescribed and physicians and pyschiatrists who prescribed the medications, as entered by the patient; and

FIG. 30 is a depiction of information relative to the address and contact information, of the patient, the employer of the patient, the preferred hospital of the patient and, preferably, a map showing locations thereof.

### DESCRIPTION OF THE PREFERRED EMBODIMENT

The management method and system is architected to handle crisis situations wherein the patient is either harmful to himself or others. If harmful to himself, information related to the event, whether it involves a suicide attempt or other serious episode, can be recorded. Manic episodes can involve patients getting into serious trouble and/or putting others in harm. As such, the system will record information on the event, along with associated parameters for concerned personnel, such as lawyer, court, probation, registry of motor vehicles, insurance, and police, and any other selected stations.

Because of the sensitive nature of the data collected, the system enforces a high degree of security, such that it resists being hacked by an outside party. The system runs on Windows, Macintosh, Windows Mobile, Palm, and Blackberry devices. Because of patient confidentiality, the system should not be offered as a hosted service over the web.

Results from the journal can be transmitted to stations of a psychologist and/or psychiatrist or physicians treating the patient, or loved ones, via the other stations or Email or Instant Messenger, and the data is stored such that all parties involved with the patient can access the data. Exposed services and application programming interfaces are made available, such that management systems may be used in conjunction with the patient's records. Reports are also available for the patient to print out prior to psychologist, psychiatrist, group and other counseling sessions. If multiple users utilize the system to record information on a single patient, the system can be configured such that stations are blinded to not display input from other stations that are recording patient data.

Users of the system are able to personally define in the journal:

1. Stressors (examples: not enough or too much sleep, becoming too busy, uneven level of activity, using alcohol or street drugs, isolating one's self, stress at work, lack of exercise, etc.).

2. Triggers (major events such as: moving, changing jobs, getting married, breaking up, seasonal changes, holidays, illness, disagreements with family or friends, problems at work, death of a loved one, starting college, starting a new job, stopping medicine, starting medicines for depression or other medicines and herbal products, having thyroid problems and other medical conditions, etc).

3. Crisis events, such as suicide attempt, or an arrest, or citation, that then pull lawyers, courts, probation, and police into the patients's life.

4. Relationship issues

5. School or work issues; employer information

6. Anxiety

7. Indecisiveness

8. Irritability

9. Paranoia

10. Guilt

11. Isolation

12. Social anxiety

13. Sexual activity

14. Psychosis

15. Medications taken; pharmacy information

16. Side effects from medications

17. Hours slept

18. Energy level

19. Speech (rate and amount)

20. Thought disorder

21. Appearance

22. Health issues; physical exams

23. Alcohol and drug intake

24. Smoking

25. Exercise routines

26. Fun activities

27. Weight, particularly gain or loss beyond “normal”

28. Time outside

29. Sugar intake

30. Salt intake

31. Caffeine intake

32. Calcium intake

33. Fish Oil intake

34. Folic Acid intake

35.B Vitamins (B complex, B1—thiamine, B6, B12) intake

36. Vitamin C intake

37. Vitamin E intake

38. Magnesium intake

39. Zinc intake

40. Daily diet note

41. Overall mental status

42. Doctor information

43. Family, friends, support group information

44. Hospital information

45. Lawyer information

46. Medical insurance information

47. Pharmacy information

48. Probation Officer information

49. Diagnosis information

50. Thoughts and feelings

51. Conflicts

52. Diet

Responses that are cause for concern in the journal are automatically highlighted.

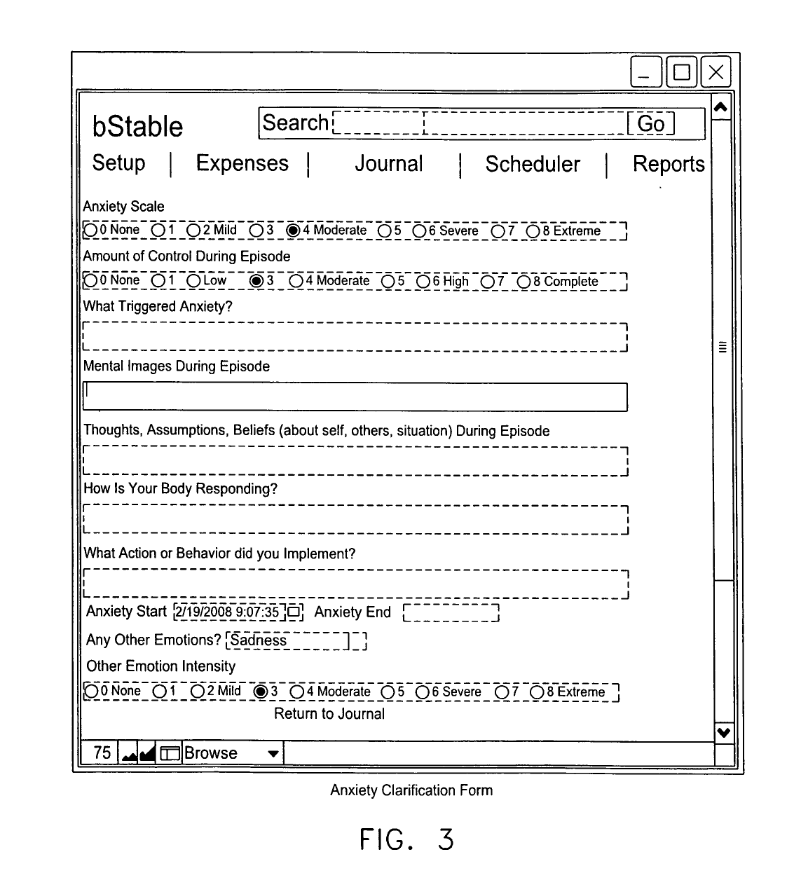

An example of the journal triggering a workflow is if a patient were to enter “Yes” to “Anxiety” (FIG. 3). This goes beyond capturing on a 1 to 10 scale the level of anxiety the patient is experiencing, but rather delves deeply into the anxiety to reveal the true nature, causes, and circumstances of the episode. If the patient thinks he/she is becoming paranoid, or becoming psychotic, information can be entered to clarify this thinking.

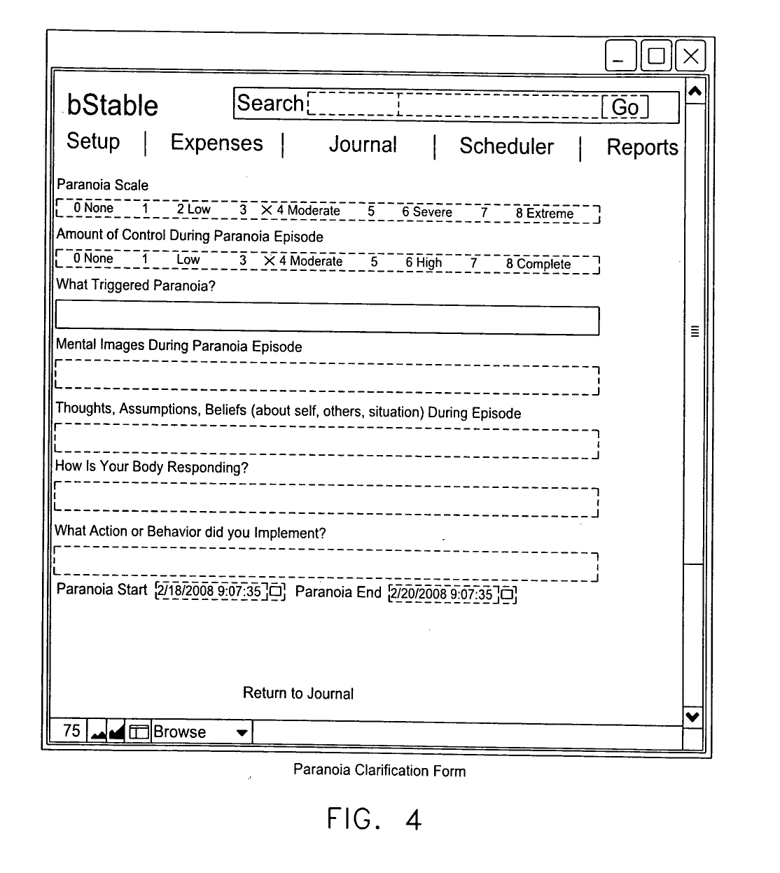

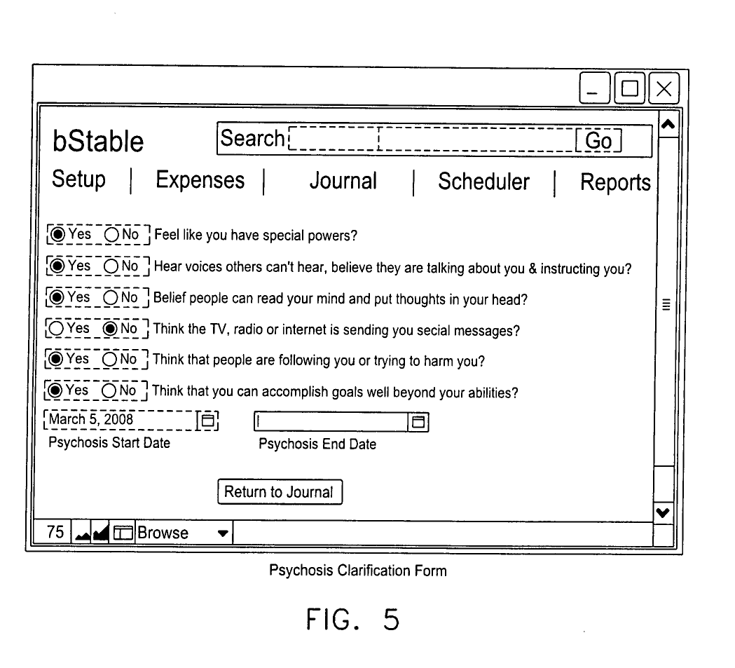

The method and system are designed such that patients do not usually have to say “Yes” or “Maybe” to a Crisis event in their daily journal, but in some instances it can be appropriate. If it is, the system begins a series of information collection processes (FIGS. 4 and 5).

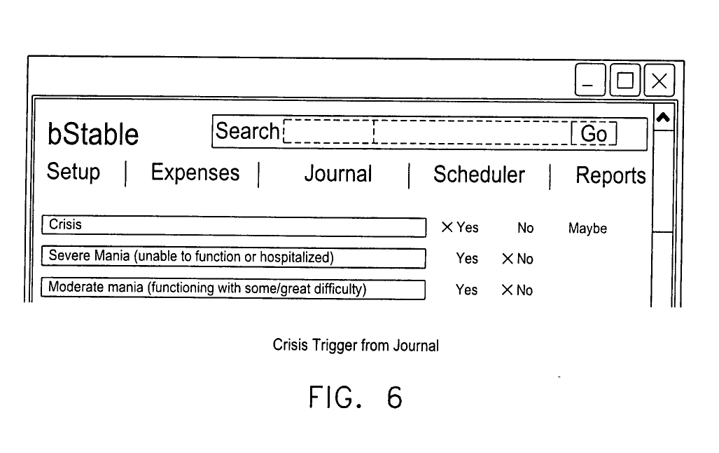

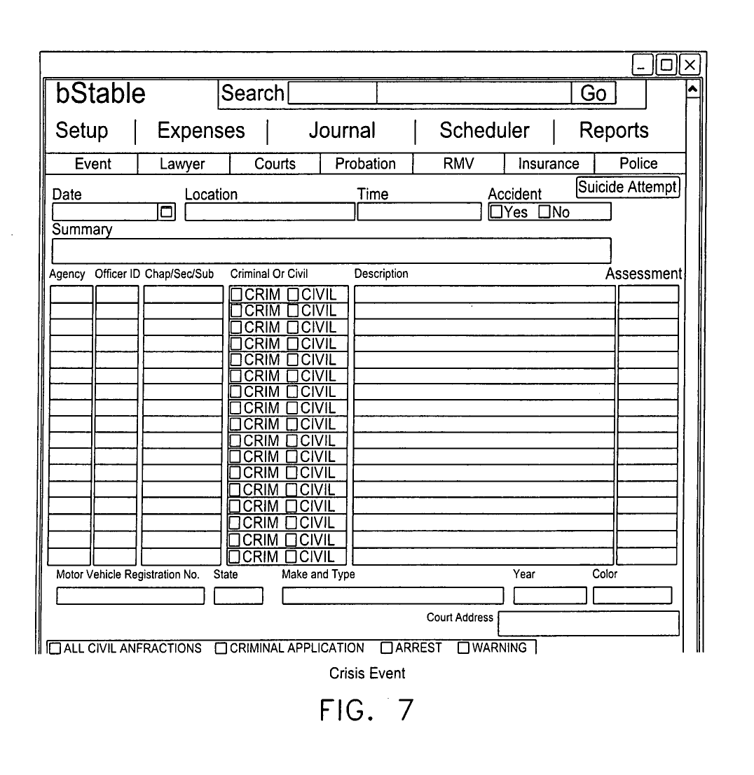

A crisis event can be captured (FIGS. 6 and 6A) along with any sort of police citation information. A high percentage of manic episodes involve motor vehicles. As such, Registry of Motor Vehicles and insurance information associated with the vehicle involved in the civil or criminal incident can be captured. If the event involves a suicide attempt, information can be captured related to the event.

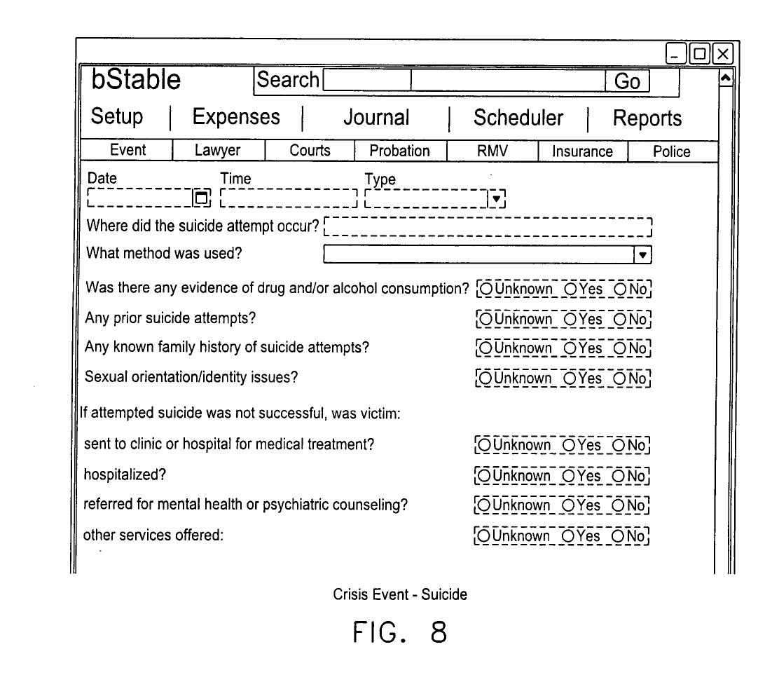

Information on a suicide attempt can be captured as seen in FIG. 8. If the patient is sent to a hospital, the system will kick off a series of workflows to help the patient through the process, such as how to prepare for the visit and what to do while at the hospital.

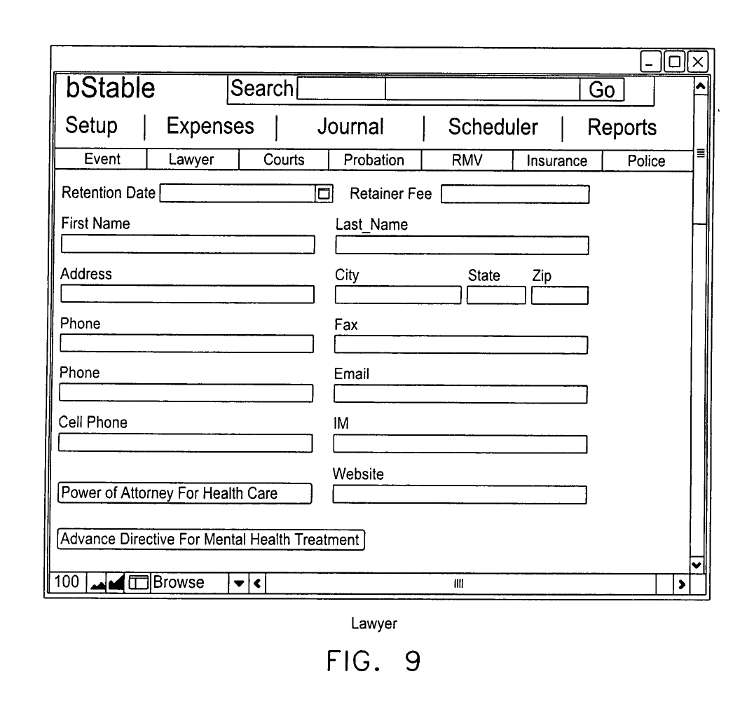

Lawyer information needs to be maintained in cases in which a manic episode ends in an arrest or hospitalization. From one screen shown in FIG. 9, a Power of Attorney for Health care, and an Advance Directive for Mental Health Treatment can be created, linked to, or viewed. The Advance Directive for Mental Health Treatment includes points including what psychotropic medications the patient will accept, whether the patient will allow electroconvulsive therapy, and the patient's preference for emergency treatment, such as restraint, seclusion, or medication.

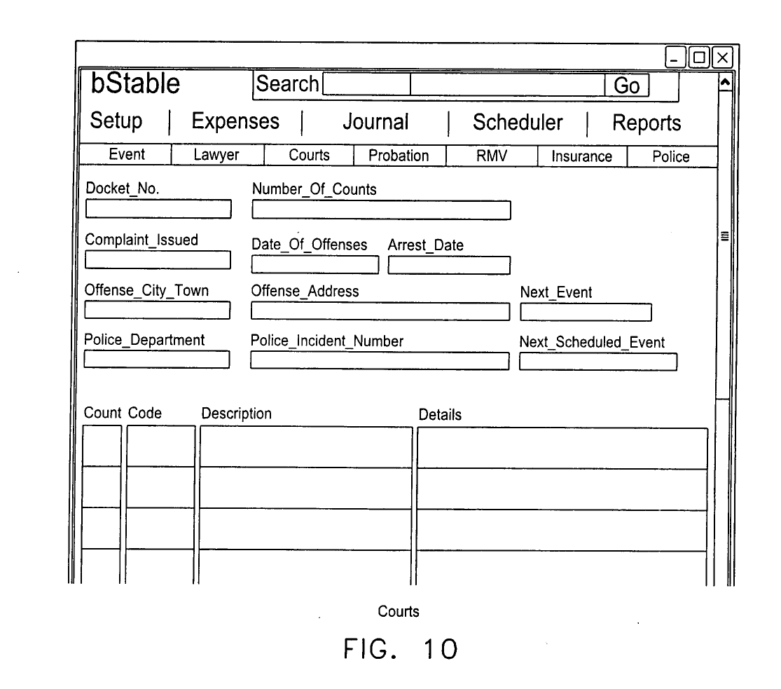

Criminal or civil complaints issued are recorded and court dates are synched with a calendaring module, as illustrated in FIG. 10.

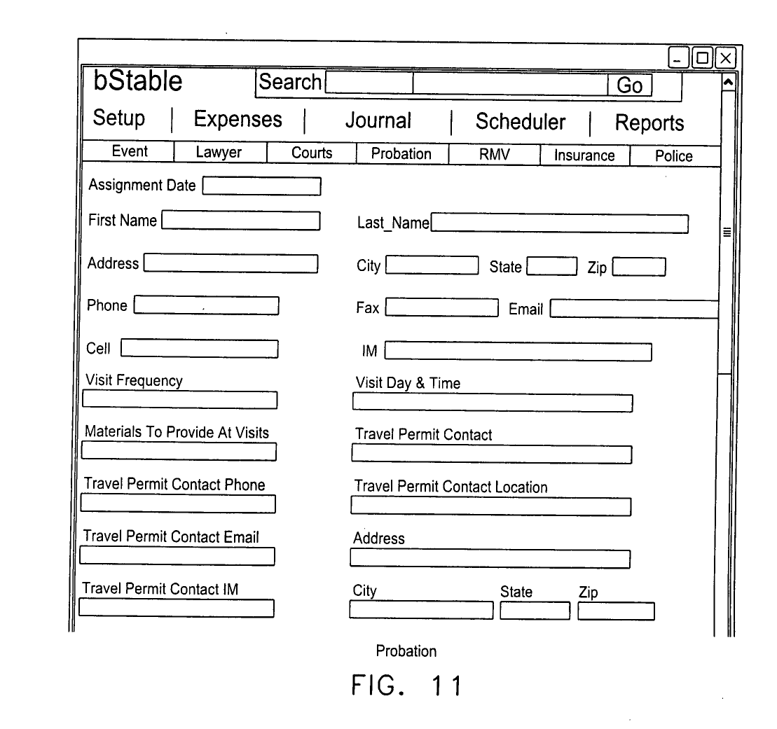

If a court rules that probation is needed, information on the probation conditions can be stored (FIG. 11) so that the patient is aware of the rules and stipulations governing the probation.

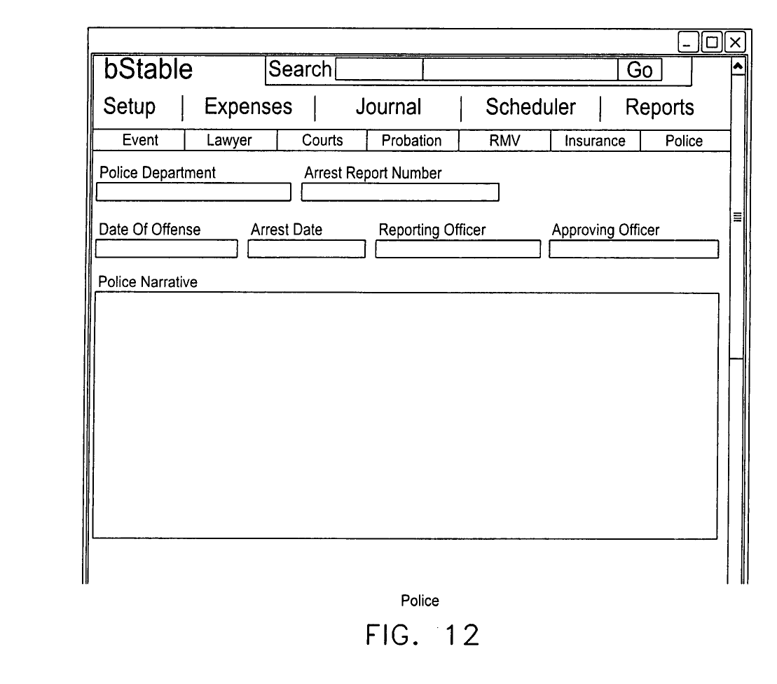

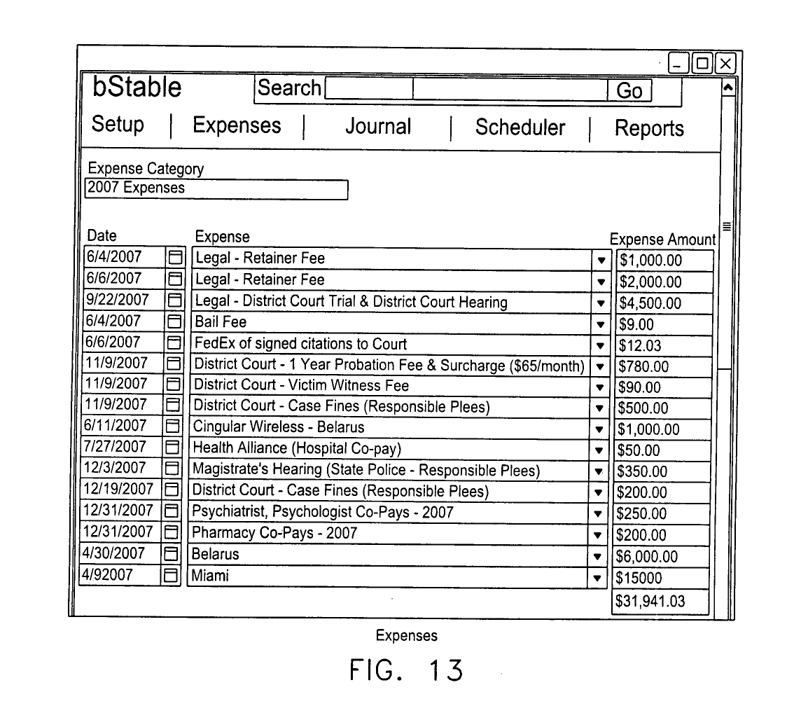

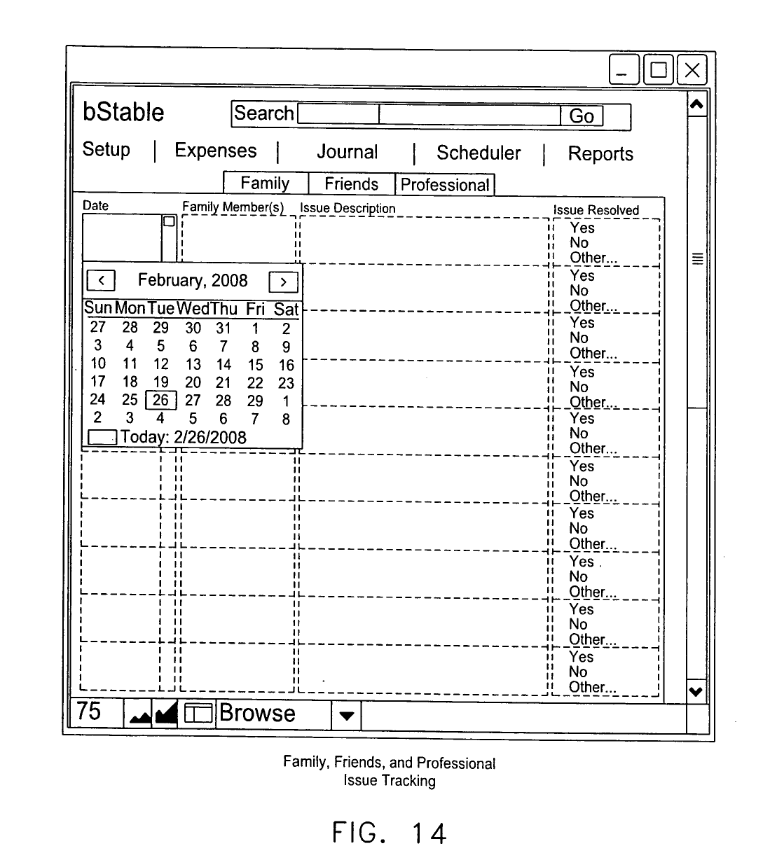

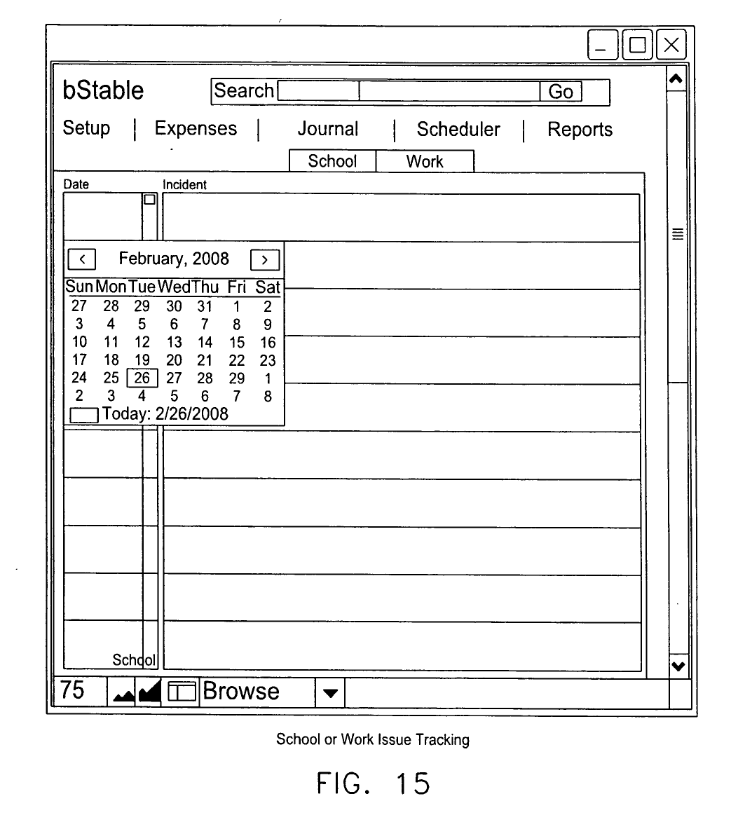

If the event involves the police, information from the police department can be added to the system (FIG. 12) to tie back to the patient's history records.

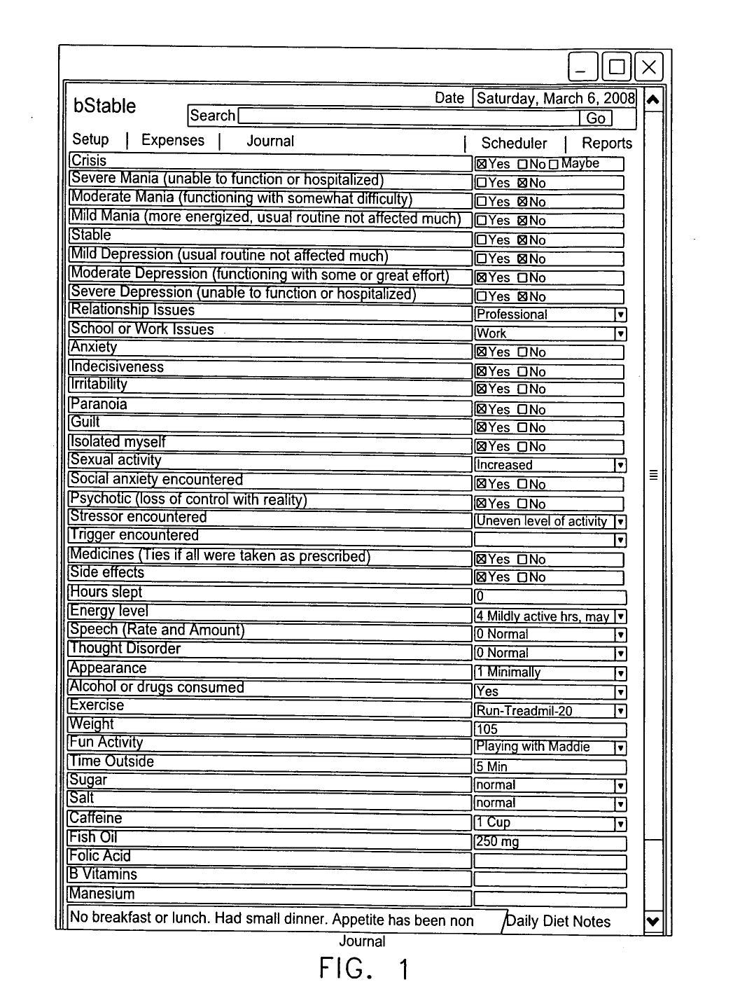

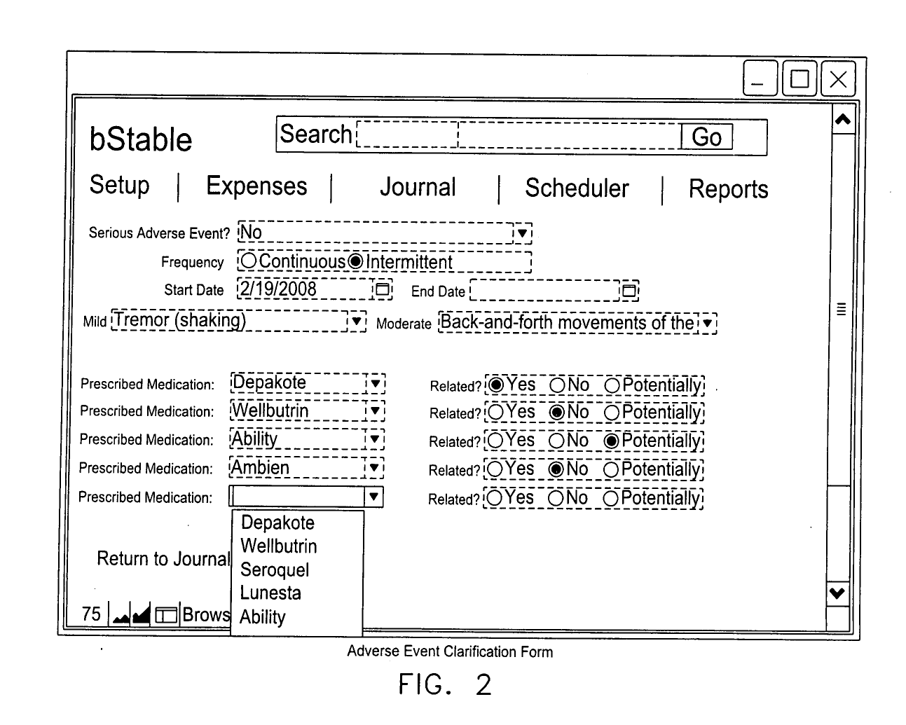

If a manic episode is encountered, the financial responses entered in the journal (shown in FIG. 1) can trigger information workflows including: crisis (suicide attempt, arrest), relationship issues, school or work issues, anxiety, irritability, paranoia, guilt, isolation, sexual activity, social anxiety, psychosis, stressors, triggers, side effects, hours slept, energy level, speech, thought disorder, appearance, and alcohol or drug consumption. In the example shown in FIG. 2, the patient entered “YES” when asked if any side effects were encountered after taking the prescribed medication. This entry then triggers the screen of FIG. 2 to capture all concomitant medication the user took, mild and/or moderate, adverse event symptoms, and whether the patient thinks the symptoms are related to a particular concomitant medication.

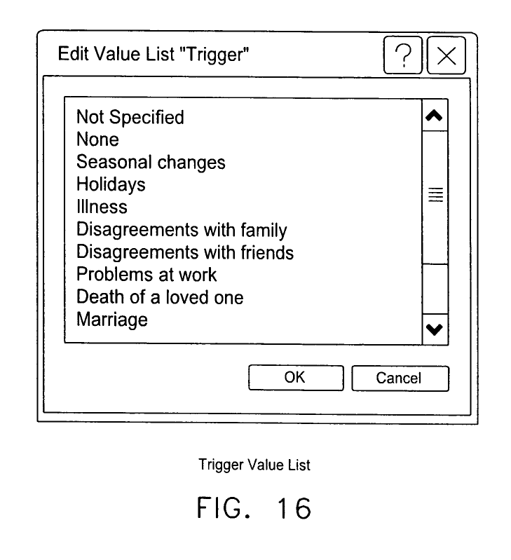

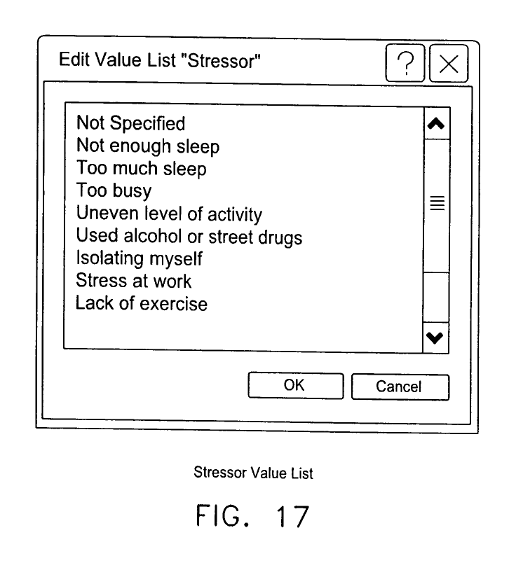

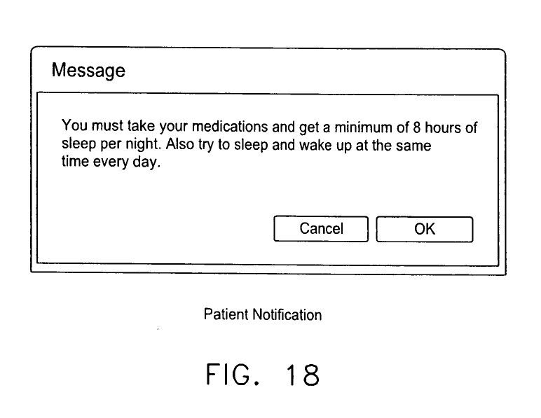

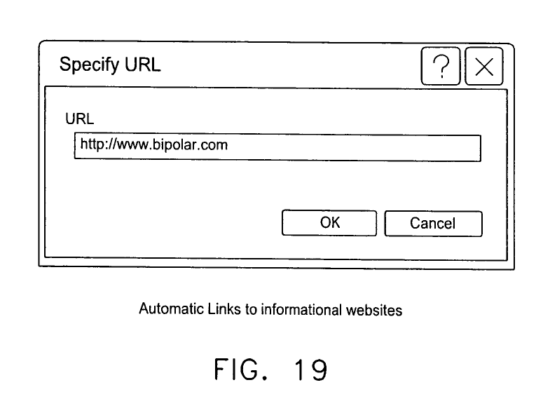

Personalized stressors and triggers are important to keep track of and manage the system's inherent flexibility and allows patients to enter their own stressors and triggers in the system to call out in their daily journals, as illustrated in FIGS. 16 and 17.

One of the major causes of manic and depressive episodes is lack of sleep and missed medication. Sleep parameters can be entered in the system (minimum/maximum values, time to go to sleep, time to wake). Based on those sleep parameter values, the system can trigger events such as patient notification, Email, SMS message to the psychiatrist, psychologist, loved ones, display of informational web pages, etc. If responses to questions cause reason for concern, mental health professionals can also be instantly alerted via email or text messages. This is achieved by advanced search algorithms that search the database of the system.

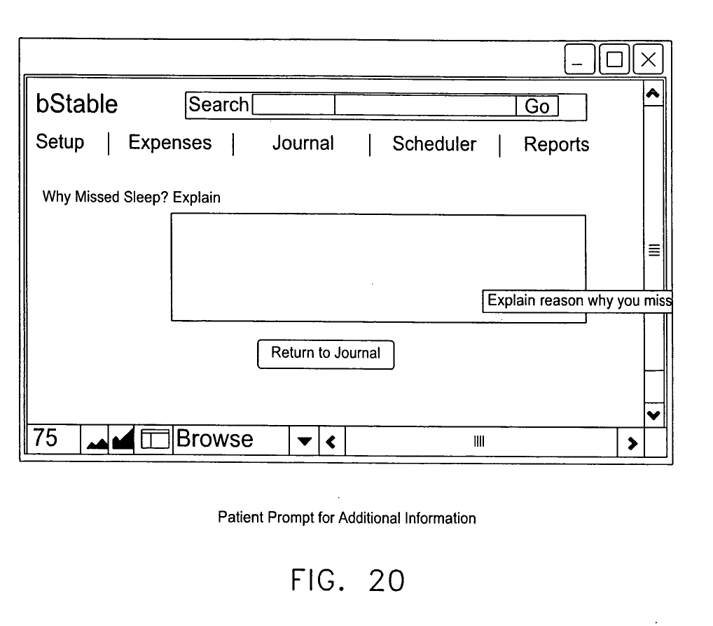

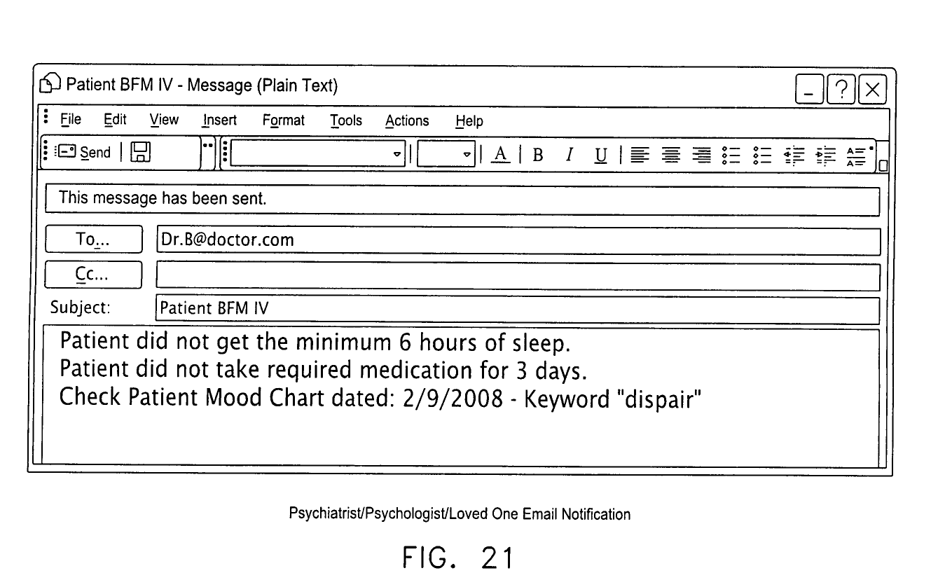

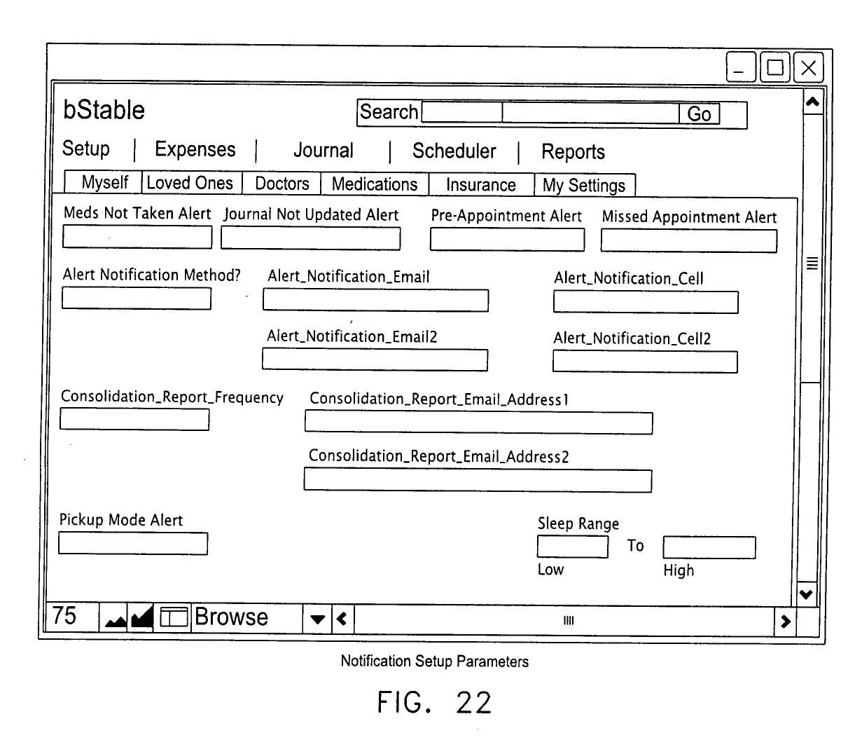

As shown in FIGS. 20 and 21, major changes in sleep habits or inability to get out of bed or decreased need for sleep, can be entered and recorded in the system.

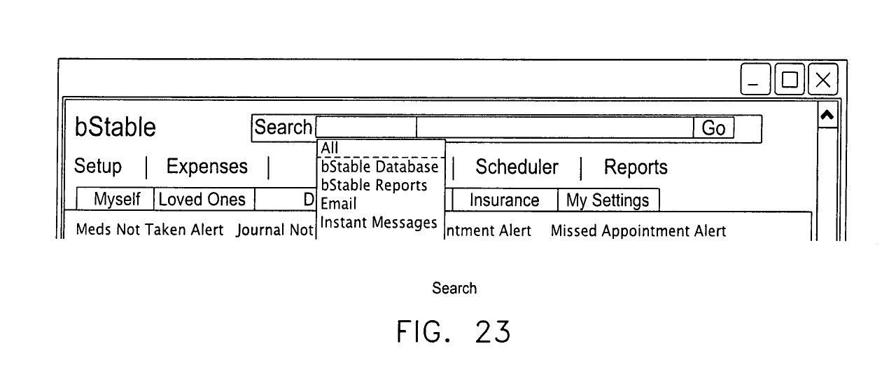

The system presented herein provides a robust method and search mechanism such that all of the patient's data is searchable. The search can also be expanded to the user's email, instant messages, or over the web. Configurable saved search report parameters can be saved and re-used (FIG. 23).

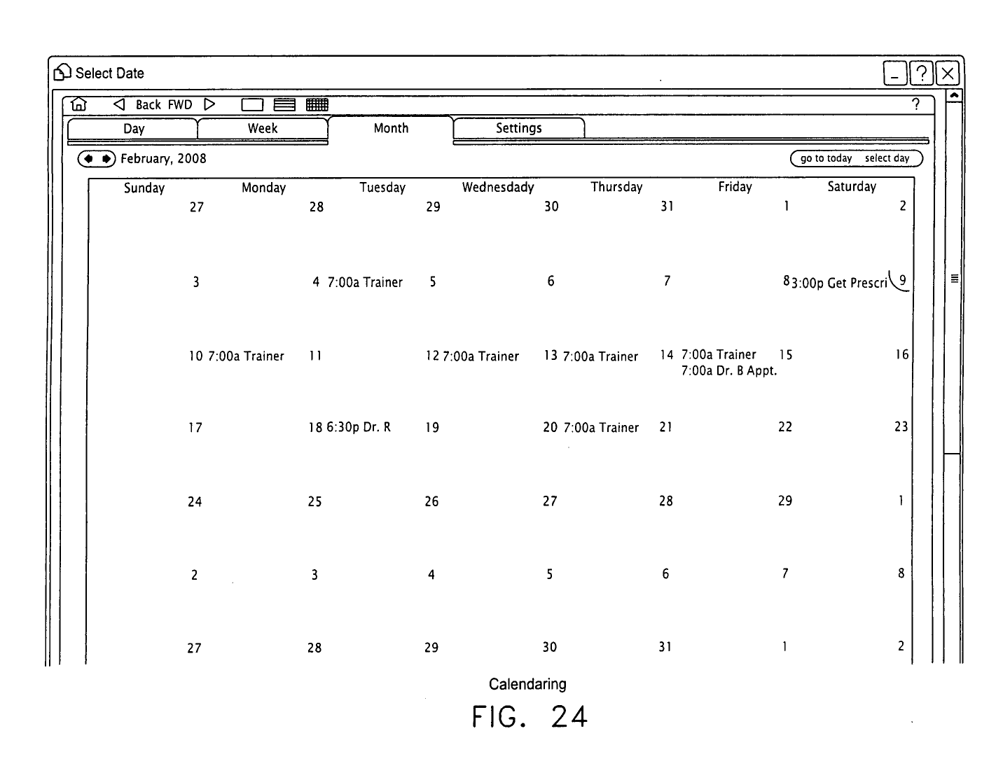

Managing bipolar disorder involves much scheduling. The system includes a configurable calendaring module (FIG. 24) to keep track of scheduled events, such as:
Psychiatrist visits
Psychologist visits
Medical doctor visits
Lab test appointments
Prescription refill pickups
Medication taken
Probation officer visits
Lawyer visits
Preventative health scheduling information such as personal trainer visits
Support group events
Phototherapy sessions
Religious events

The system also allows the patient to plan ahead for the holidays weekends, and the like, and to provide sufficient time at the end of the workday to “unwind”.

Standard report sets (i.e. medication taken over a period of time), can be used as a tool to research a patient's history to identify critical patterns. These will include, but not be limited to:
Sleep Charts, including Hours Slept, Bedtime, Wake time
Missed Medications
State Trending
Exercise Trending
Alcohol Consumption
Drug Consumption
Other Prescription Drug Consumption
Adverse Event Reporting
Missed Appointments (doctor, support group, trainer, etc.)
Weight Trend
Missed Meals
Caffeine Consumption
Sugar Consumption
Salt Consumption
Fish Oil Consumption

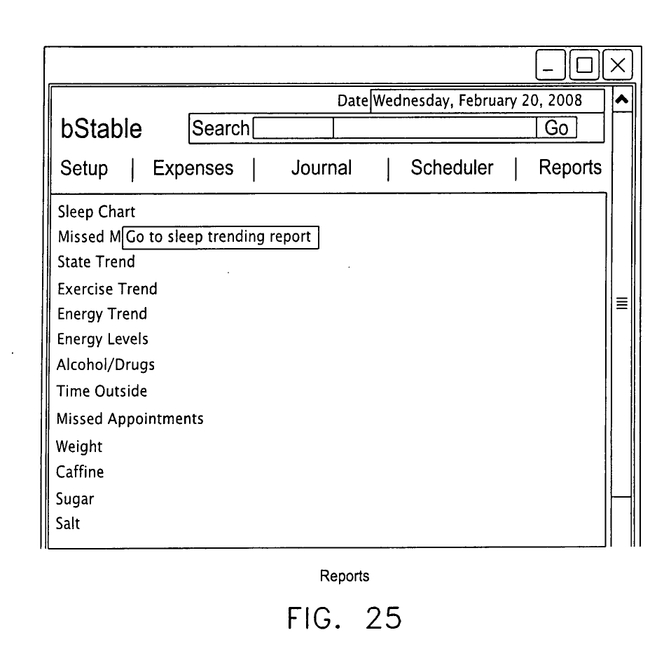

Patients are also able to build their own patient defined report sets based on any of the parameters collected in the system (FIG. 25).

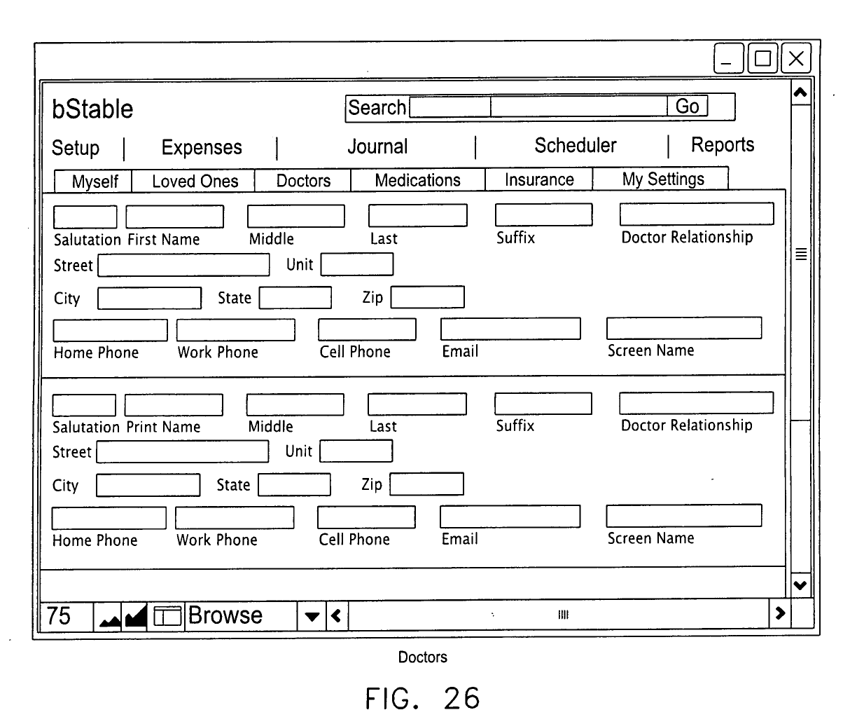

The method and system maintains a record (FIG. 26) of all current and past health care providers and their emergency contact information. This information is tied into scheduled physical exams, lab tests (blood tests, liver function tests, urinalysis, MRI or CAT scans, EKG, EEG, spinal tap, thyroid function tests, hormone test). The method and system provide the ability to capture the results of such exams and tests, if the patient wants to record this information. This module can also capture information related to prescription assistance programs if the patient requires such help.

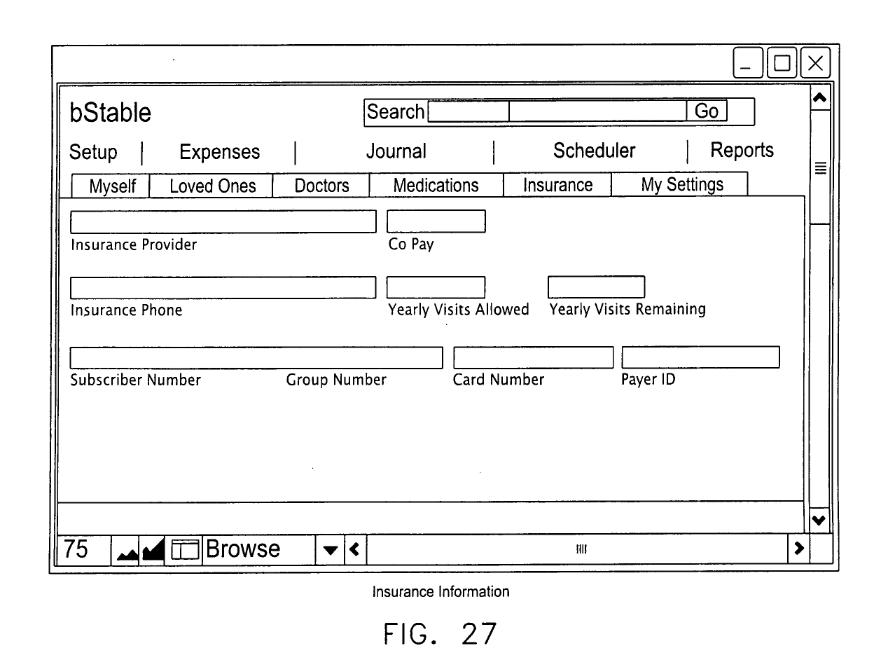

The system keeps track of private or government (Medicare, Medicaid, Disability) insurance information for doctor visits, co-pays, prescriptions, and the like (FIG. 27).

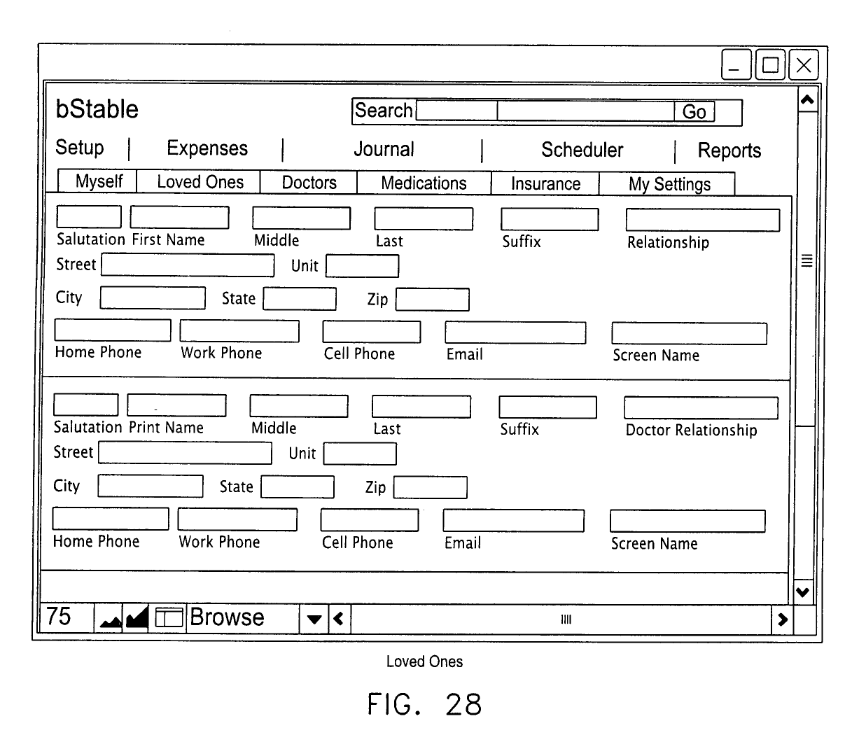

It is important that a list be maintained of loved ones to contact if the patient is not doing well. Part of the system maintains this information (FIG. 28). The system can attach to a loved one a signed Treatment Contract that in times of severe mania or depression can be produced by the loved one to the patient and/or health provider with treatment instructors, such as hospital procedures.

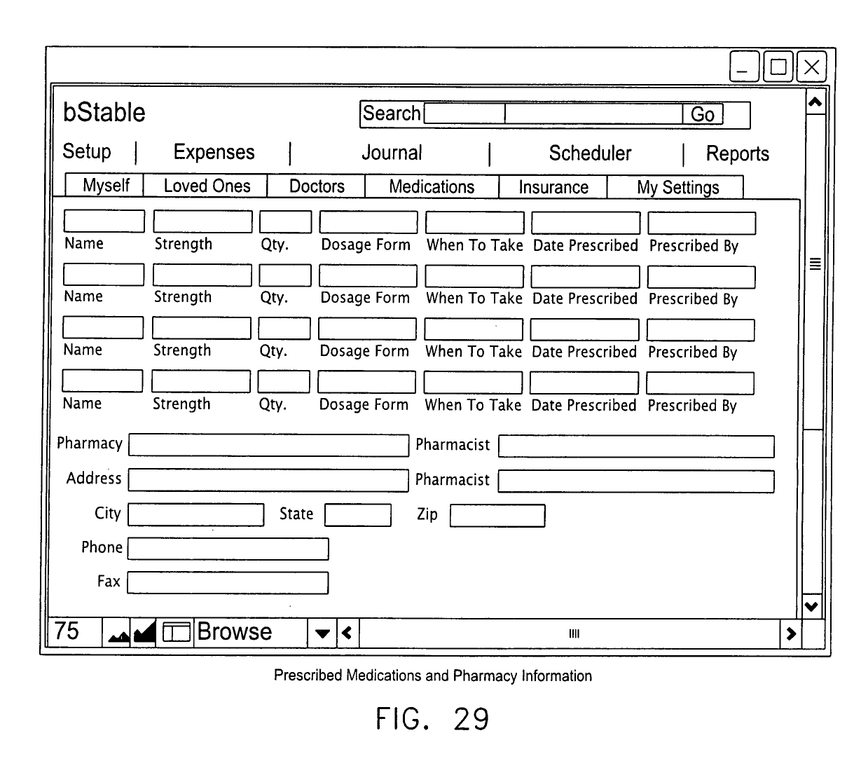

A list of all prescribed medications, along with when they were prescribed, and by which psychiatrist or physician, is recorded in the system (FIG. 29), along with psychiatrist and physician emergency contact information. Medication dosing information is linked to the Calendaring module to ensure patients are taking prescribed medication at properly established intervals. Daily email reminders can be sent out in the morning to remind patients to take medication, as well as record information in a daily journal.

The screen illustrated in FIG. 28 is for physician/psychiatrists/psychologists/loved ones to have the latest accessible contact information available on the patient in order to contact them and the preferred hospital, if hospitalization is necessary. A webpage is automatically launched within the system upon entry into this page to show location information for the patient, patient's employer, or patient's preferred hospital. There is a link via a Family History button to capture and access information regarding the patient's family and their association with bipolar disorder.

Using the management method described herein, there exists an ability to capture other physical and psychiatric conditions simultaneously occurring with the patient. These may include, but are not limited to, autoimmune disorders, cancer and tumors, endocrine disorders, infectious diseases, neurological disorders, other psychiatric disorders, unexplained conditions, incompatible medications, vitamin deficiencies, toxicities and head trauma.

The method and system set forth herein provide the ability to capture a patient's personality disorder, i.e., antisocial personality disorder, borderline personality disorder, histrionic disorder, narcissistic personality disorder).

If the patient is a child or an adolescent and reports depression, the system searches for depression symptoms, such as lack of enthusiasm or motivation, unusually “clingy” or separation anxiety, crying easily or excessively, fascination with morbid objects, and frequent complaints of physical problems, such as headaches and stomachaches. If a patient develops bipolar disorder in childhood or early adolescence, the system is adapted to search for significant hyperactivity and distractability, excessive involvement in multiple projects and activities, explosive and/or lengthy tantrums and rages, daredevil behavior, and play that involves excessive aggression or sad themes, defiance of authority and serious acting-out behaviors, such as stealing and vandalism, and strong and frequent cravings, often for carbohydrates and sweets.

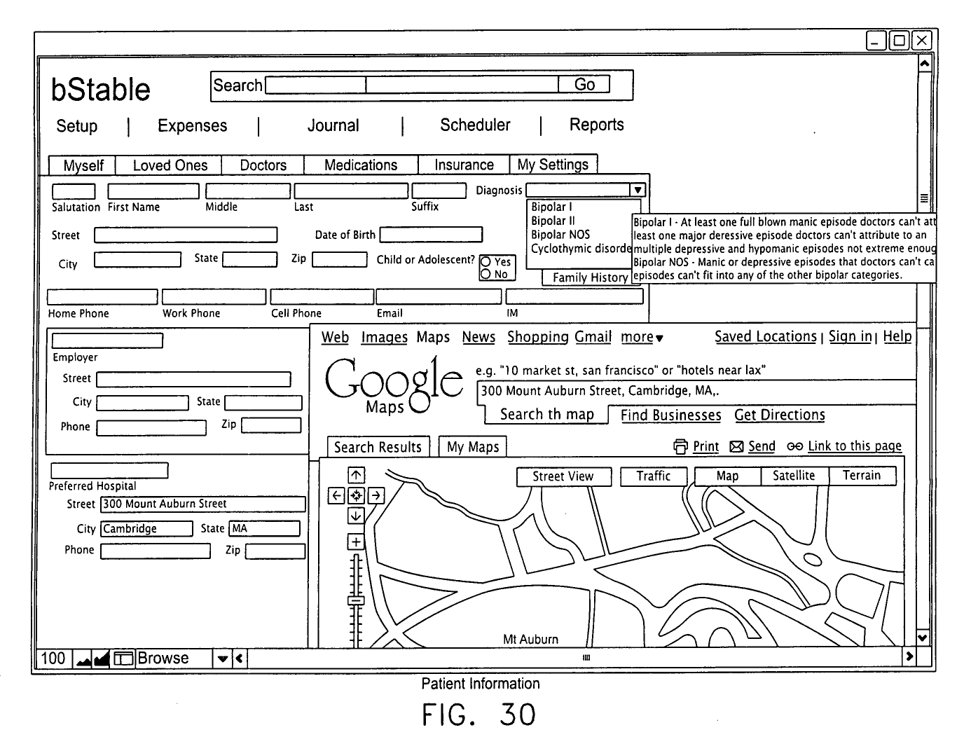

A patient information screen (FIG. 30) is maintained so that physicians, psychiatrists, psychologists, and loved ones are afforded the latest accessible contact information available on the patient in order to contact the patient.

Unless the patient agrees, access to information the patient enters about himself is not available to others. Patients enter system-wide information for themselves; doctors and loved ones enter-information for the patient. Information entered by users are in separate silos but are subsequently brought together in the form of reports for the purpose of analysis of the patient from different people's perspectives.

Patient specific stressors and triggers experienced during a day, such as key thoughts and emotions, physical sensations, behaviors implemented, and attention focus, related to the stressors and triggers can be recorded in the journal for further analysis.

The system allows for behavior experimentation tracking and management, whereby the patient can enter a prediction or theory (thought, belief, or theory being tested along with the percentage strength of conviction (1-100%), the experiment (what the patient will do, including where, when, how, with whom), results (what actually happened including thoughts, emotions, physical sensations, other people's behavior), and conclusions/comments (what is learned about prediction or theory with a re-rate of conviction). Negative core beliefs are identified via relevant early/past experiences, core unhelpful beliefs, rules/assumptions, avoidance and compensatory behaviors and then a counter which is the personal strengths and assets the patient has going for himself to combat the negative core belief. Daily healthy belief re-enforcement exercises are implemented, whereby a healthy belief is measured as a conviction percentage and then attacked and then re-defended with a final re-conviction percentage. Problems either related to the defined stressors or triggers (or not) are defined as a problem statement describing the feeling about the problem situation leading to certain behavior. The severity of the problem is indicated and a goal related to the problem is recorded and achievement toward the goal is recorded and adjusted on a daily basis. A patient can enter a social setting situation, who with, where, what doing, social phobia control exercise implemented, feelings, results, and attention percentage to self or task.

The system accepts and stores diagnosis, diagnosis date, diagnosed by, family history, other physical or psychiatric conditions, non-mood disorder related medication, patient contact details, doctors, employer, family, friends, support groups, hospitals, lawyers, medications, medication insurance, pharmacies, probation officers, vehicles, vehicle registration and insurance information, plan and history of electroconvulsive therapy, or rapid transcranial magnetic stimulation, and any associated memory loss. The system further accepts and stores physical exam information: vitals, physical exam history, standard lab tests, thyroid tests, and hormone tests, as well as other data stored, can include unstructured observational data related to the patient, medication regime, medication regime change, notes related to daily medication usage, medication adverse events (serious, moderate, or mild), frequency-start & stop date, sleep tracking; including naps (length and number), sleep (thoughts prior to sleep, dreams, thoughts if woken during night, thoughts upon waking, medication taken before going to sleep), mood (stable, depression level, mania levels), crisis information (courts, police, probation, suicide attempts) can be recorded, physical exercise planning and detailed exercise completion against the plan is maintained.

Further entries into the system include legal documents, such as treatment contract, hospitalization procedure, power of attorney over mental healthcare, advance directive for mental health treatment, instruction directive, proxy agent directive is maintained.

The system is adapted to generate alerts displayed upon login, and alert summary email sent to designated recipients, pertaining to journal updates, medication taken, sleep out of range, alcohol/drugs consumption, lack of exercise, conflicts, reported isolation based on alert parameters specified in the system.

Daily feelings can be recorded, including:

1. Anxiety Level and (anxiety scale, control over anxiety, what triggered anxiety, mental images during episode, thoughts, assumptions, beliefs about self or others or situation during episode, how body responded, action implemented, anxiety start, anxiety end, other emotions, other emotion intensity)

2. Indecisiveness Level

3. Irritability Level

4. Paranoia Level and (paranoia scale, control over paranoia, what triggered paranoia, mental images during episode, thoughts, assumptions, beliefs about self or others or situation during episode, how body responded, action implemented, paranoia start, paranoia end, other emotions, other emotion intensity)

5. Guilt Level

6. Psychosis Level and (psychosis scale, start and end date, special powers?, voices?, mind being read and instructed?, given special instructions, people trying to harm you, can accomplish goals beyond abilities, psychosis notes)

7. Thought Disorder Level

8. Energy Level

9. Concentration Level

Relationship issues can be tracked (family, friend, school, work-person's relation to the patient, name, issue description, if issue was resolved).

Still further entries can include activities (doctor appointments, isolation, sexual activity level, speech rate level, appearance level, if exercised, daily routine structure level, if gambled, goal directed activities performed, relaxation techniques implemented, fun activities performed, time outside, menstrual period, weight), diet, appetite change, alcohol/drugs consumed-if consumed, what, what quantity and why, nicotine consumed, sugar, salt, caffeine, fish oil, folic acid, b vitamins, magnesium, daily diet notes.

Still further entries may include adolescent or child (depression and excitability tracking and reporting modules) focused on enthusiasm/motivation, dinginess, complaining, crying, hyperactivity, excessive involvement in activities, tantrums, daredevil behavior, aggression, defiance, acting out, cravings; and expenses, schedules, and keeping track of any scheduled appointments or tasks that could or could not be related to the disorder including: primary care physician appointments, medication to take, pharmacy pick-ups, psychiatrist appointments, support group meetings etc.

A report can be produced and distributed to a support team, usually including loved ones and medical providers, but also patient contact information, diagnosis, diagnosis date, doctors, family members, support groups, hospitals, medications, concomitant medications, insurance information, other physical or psychiatric conditions, crisis triggers, calming actions to implement, danger prevention, emergency room staff directives, reason life is worthwhile and importance of recovery. This information is prepared by or with the patient when the patient is in a stable state.

The reports can be run on selected charts printed out or emailed to specified email addresses for the number of days and selected and distribution frequency schedule. The last distribution date on which the report was last sent is maintained.

Preferably, an alert can pop up in the journal and selected stations if the patient's journal has not been updated, and/or if the patient's medication usage has not been recorded, and/or if the patient has not gotten the sleep as specified in a sleep range parameter, and/or if the patient has consumed drugs or alcohol in the past month, and/or if the patient did not exercise as per schedule, and/or if the patient had any conflicts in the past month, and/or if the patient has isolated himself or herself over the past month.

A summary email of all alerts may be sent out to specified recipients, but only if the patient enables the setting.

It will be understood that many additional changes in the system details and method steps, which have been herein described and illustrated in order to explain the nature of the invention, may be made by those skilled in the art within the principles and scope of the invention or expressed in the appended claims.

What is claimed is:

1. A method for managing bipolar disorder in a patient, the method comprising:
providing an electronic journal for the patient, and a plurality of electronic stations for participants in communication with the journal and with selected other of the plurality of electronic stations, wherein there can be recorded and communicated by the patient, and by the participants, pertinent data, patient events, and patient responses to events, selected ones of the data, events and responses being unavailable to the patient, and unavailable to selected ones of the stations, the journal including a calendaring and timing facility to identify, report, and record dates and times of events, medical tests results, and information relative to medical and related matters, persons to be contacted under specified conditions, medicines prescribed, and medicines and other consumables deemed helpful or harmful, wherein the stations are adapted to build a history of events and data overtime;
entering by the patient in the journal or by a participant in one of said stations a selected event or data; and
transmitting the selected event or data to the selected other stations;
wherein the events and data are related to manifestations of the bipolar condition and events and data which affect the patient and the participants.

2. The method in accordance with claim 1, wherein the journal is adapted to receive and preserve information from the patient relative to selected ones of a crisis, stressful issues, anxiety, irritability, paranoia, guilt, isolation, sexual activity, psychosis, and side effects of medications.

3. The method in accordance with claim 1, wherein the journal is adapted to receive and preserve information from the patient relative to people and entities to be contacted in the event of need, including selected ones of a lawyer, a probation officer, police, family, friends, school and/or workplace persons, a physician, a psychiatrist, a psychologist, loved ones, insurance agent, and pharmacy.

4. A system for managing parameters instrumental in treating and coping with bipolar disorder, the system comprising:
an electronic journal for use by a patient having bipolar disorder, wherein is recordable and transmittable data relative to patient events, responses to events, medications and responses thereto, data relative to schedules, personal and professional contacts;
a plurality of electronic stations wherein is recordable and transmittable to the journal and selected ones of other stations pertinent data, patient events, patient responses to events;
selected events and responses being not available to the patient and selected ones of the stations;
said journal and said stations each including a calendaring and timing facility to identify, report, and record dates and times of events, medical test results, and information relative to medical and related matters, entities to be contacted under specified conditions, medicines prescribed, medicines and other consumables deemed helpful or harmful to the patient;
the journal and the stations being selectively adapted to build histories of events and data over time;
wherein the journal is adapted to receive input from the patient and from the stations and transmit the inputs only to selected ones of the stations;
wherein the stations are adapted to receive inputs from selected entities and to transmit the inputs to selected ones of the stations; and
wherein the inputs comprise events and data related to manifestations of the bipolar condition and data related thereto.
